(19) United States
(12) Patent Application Publication
(10) Pub. No.: US 2011/0302575 A1
(43) Pub. Date: Dec. 8, 2011

(54) PRINT CONTROL APPARATUS AND DISPLAY METHOD FOR THE SAME

(75) Inventor: Yuichi Hasama, Kawasaki-shi (JP)

(73) Assignee: CANON KABUSHIKI KAISHA, Tokyo (JP)

(21) Appl. No.: 13/115,581

(22) Filed: May 25, 2011

(30) Foreign Application Priority Data
Jun. 7, 2010 (JP) 2010-130449

(51) Int. Cl. G06F 9/445; G06F 3/12

(52) U.S. Cl. 717/174; 358/1.15

(57) ABSTRACT

In a print control apparatus that searches for and installs a printer driver supporting a specified output device, hardware information on the output device is obtained by searching the output device. A printer driver that matches the output device is searched from the obtained hardware information, and based on the search results, the display of the output device is switched.

### BACKGROUND OF THE INVENTION

1. Field of the Invention

The present invention relates to a print control apparatus that searches for and installs a printer driver supporting a specified output device and to a display method for the same.

2. Description of the Related Art

Conventionally, to utilize an output device, such as a printer, from an information processing apparatus, such as a personal computer, it was ordinarily necessary to install a specific printer driver supporting that output device. Therefore, if a plurality of output devices were utilized, then the same number of printer drivers as utilized output devices had to be installed.

What is more, for every use, the user was forced to perform a troublesome installation operation of looking up an IP address and searching a supporting printer driver on the Internet. Moreover, since in recent years, the popularity of personal computers has exploded, also the maintenance costs for printer drivers have increased to the point where they cannot be ignored anymore.

Accordingly, universal printer drivers have been researched and developed, which can be utilized by a plurality of output devices, independently from the type of output device. For example, HP Universal Print Driver Series for Windows—overview and features http://h20338.www2.hp.com/hpsub/cache/342988-0-0-225-121.html (hereinafter referred to as Non-Patent Document 1) discloses a method of printing by selecting a network printer on which output is possible after issuing a print instruction from an application to a universal printer driver. With this method, by merely installing a universal printer driver on an information processing apparatus, it is possible to utilize all printers supported by this universal printer driver.

However, in the universal printer driver disclosed in Non-Patent Document 1, all supported printers generate and send commands of a format that can be commonly processed, so that the functionality is more limited than in the case of printing using a special dedicated printer driver for each printer. Moreover, printing is not possible with printers of a type that cannot process the commands sent by the universal printer driver.

Thus, there are these two problems when using a universal printer driver, namely that the functionality is more limited than with a dedicated printer driver, and that printing is not possible with printers of a type that is not supported by the universal printer driver. In order to solve these problems, a print control apparatus is conceivable that uses a virtual printer driver.

If a virtual printer driver as described above is used, then, after printing from an application is executed, printing is carried out by installing a printer driver matching the output device. For example, the virtual printer driver displays the results of looking up output devices that are shared on a network as an output destination device list, and the user selects from this list an output device to be used for printing. In this situation, even though time was spent to find a printer driver supporting the selected output device, no printer driver supporting the output device was found, and as a result printing was not possible.

### SUMMARY OF THE INVENTION

The present invention provides a print control apparatus with which an output device supporting a printer driver that can be installed can be selected as well as a display method for the same.

According to one aspect of the present invention, there is provided a print control apparatus for installing a printer driver supporting an output device specified by a user, the apparatus comprising: an obtaining unit that obtains hardware information on an output device by looking up the output device on a network; a search unit that searches for a printer driver matching the output device from the hardware information obtained with the obtaining unit; and a display unit that displays a screen for specifying the output device if a printer driver matching the output device has been found by the search unit.

Further features of the present invention will become apparent from the following description of exemplary embodiments (with reference to the attached drawings).

### BRIEF DESCRIPTION OF THE DRAWINGS

FIG. 1 is a block diagram showing the overall configuration of a network system in accordance with one embodiment.

FIG. 2 is a block diagram showing an example of the hardware configuration of a host computer and an output device.

FIG. 3 shows a user interface screen of a printer driver installer.

FIG. 4 is a diagram illustrating information on a printer driver, a print queue and a port, as well as the relation among them.

FIG. 5 is a flowchart showing a process of installing an ordinary printer driver.

FIG. 6 is a flowchart showing an installation process of the printer driver according to the embodiment.

FIG. 7 is a diagram showing the data flow of the print process in the embodiment.

FIG. 8 is a drawing showing a sequence of the print process in the embodiment.

FIGS. 9A, 9B and 9C show examples of user interface screens.

FIG. 10 is a flowchart showing in detail a process for looking up output destination devices and displaying an output destination device list.

FIG. 11 is a flowchart showing in detail the processing of an output preparation process.

FIG. 12 is a flowchart showing in detail the processing of the universal/dedicated printer driver installation process.

FIG. 13 is a flowchart showing an output device specification process according to the modified example.

FIG. 14 is a diagram showing an example of a user interface screen in the modified example.

FIG. 15 is a flowchart showing a process for setting up a printer driver according to the modified example.

### DESCRIPTION OF THE EMBODIMENTS

The following is a detailed description of the embodiments, with reference to the accompanying drawings.

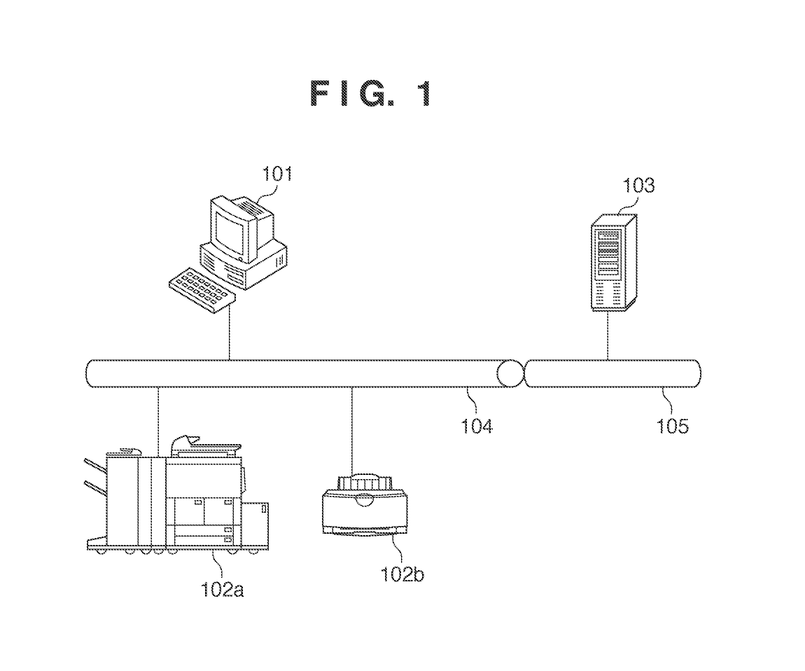

FIG. 1 is a block diagram showing the overall configuration of a network system in accordance with one embodiment. This network system includes a host computer 101, a plurality of output devices 102a, 102b, and a printer distribution server 103, for example. These are connected to each other via a LAN (Local Area Network) 104 or the Internet 105. It should be noted that the number of output devices is not limited to two, and they may include a digital multi-function peripheral, a copier, a printer or the like.

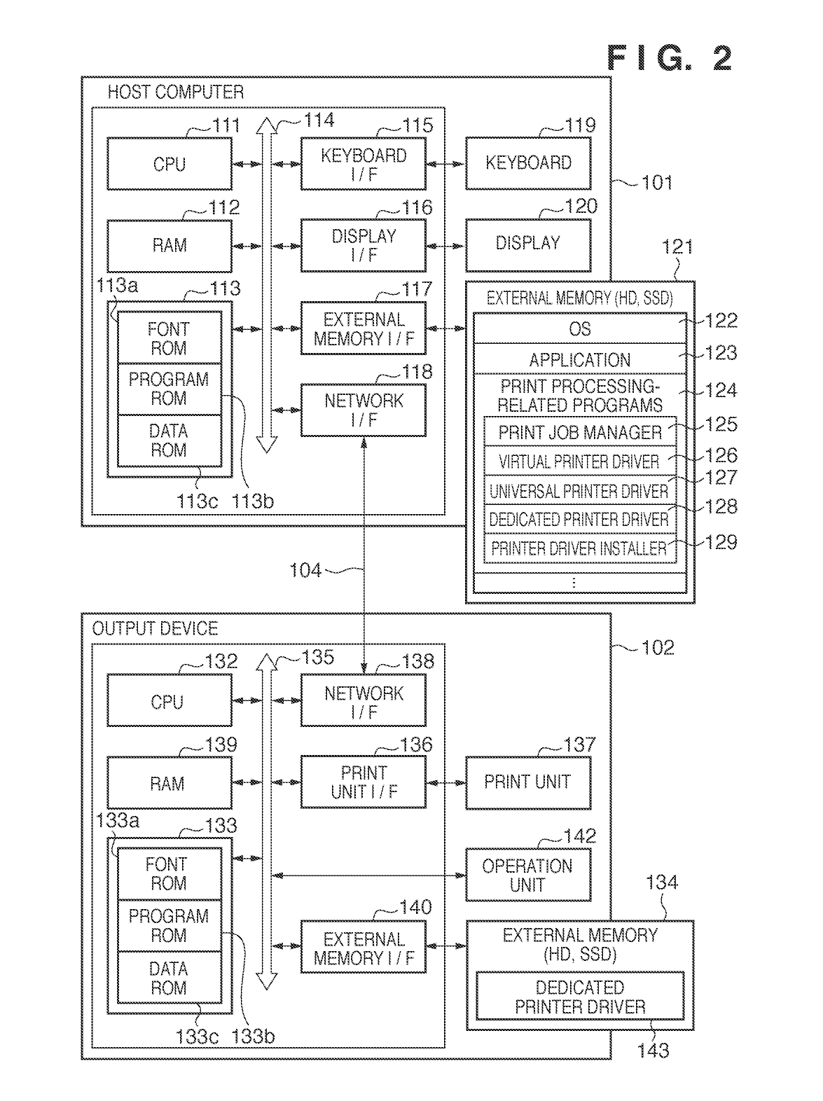

FIG. 2 is a block diagram showing an example of the hardware configuration of a host computer and an output device. In the host computer 101, a CPU 111 performs the overall control of the various devices connected to a system bus 114 in accordance with a program stored in RAM 112. The RAM 112 functions for example as a main memory or a working area of the CPU 111. A ROM 113 stores various kinds of programs or control data. Moreover, it is divided up into a font ROM 113a storing various kinds of fonts, a program ROM 113b storing a boot program, a BIOS or the like, and a data ROM 113c storing various kinds of data.

A keyboard controller interface (I/F) 115 controls key input from a keyboard 119 or a pointing device (mouse) not shown in the drawings. A display I/F 116 controls the display on a display 120. An external memory I/F 117 controls access to an external memory 121, which is explained further below. The memory 121 may be a HD (hard disk) or a SSD (solid state disk), for example. Moreover, it functions as a computer-readable storage medium storing various kinds of applications 123, such as an operating system (“OS” in the following) 122 and print processing-related programs 124. Furthermore, this external memory 121 functions as a computer-readable storage medium storing user files, editing files and the like, which are not shown in the drawings. It should be noted that Microsoft Windows™ is used as the OS 122 here.

The print processing-related programs 124 include, in accordance with the present invention, a print job manager 125, a virtual printer driver 126, a universal printer driver 127, and a dedicated printer driver 128. Furthermore, the print processing-related programs 124 also include a printer driver installer 129. The virtual printer driver 126 is a program utilized for printing a document that is typical for the embodiment not directly but indirectly on a physical output device. It is called “virtual” because it is an indirect program, but since the virtual printer driver 126 is registered as an ordinary printer driver for performing print control in the OS 122, the user can carry out an operation with a user experience that is close to that of an ordinary print operation procedure.

On the other hand, the universal printer driver 127 and the dedicated printer driver 128 are classified as ordinary printer drivers for performing print control. Specifically, the ordinary printer driver 127 is a printer driver with which the print control of a plurality of device models is possible, and can utilize the functionality shared by supported device models. By contrast, the dedicated printer driver 128 is a printer driver with which the print control for only a single device model is possible, and can assure the optimum performance of the supported device model.

The network I/F 118 is connected via the LAN 104 to the output device 102, and performs control processing of the communication with the output device 102. Here, also the printer driver distribution server 103 has the same hardware configuration as the host computer 101. Moreover, the printer driver distribution server 103 is arranged on the Internet 105, whose data transfer speed is slow, so that its communication response speed is slower than that of the host computer 101 or the output device 102.

The following is an explanation of the hardware configuration of the output device 102. A CPU 132 controls the overall operation of the output device 102. A RAM 139 functions for example as a main memory or a working area of the CPU 132, and is also used as an output information deployment region and an environment data storage region. The RAM 139 also includes an NVRAM (non-volatile RAM) region, and is configured such that its memory capacity can be increased with an optional RAM connected to an expansion port not shown in the drawings. A ROM 133 is divided up into a font ROM 133a storing various kinds of fonts, a program ROM 133b storing a control program executed by the CPU 132, and a data ROM 133c storing various kinds of data.

A network I/F 138 carries out the exchange of data with the host computer 101. A print unit I/F 136 is an interface to a print unit 137 serving as a printer engine. Access to an external memory 134 is controlled by an external memory I/F 140. Furthermore, the external memory 134 may include an optionally connected hard disk (HD), a solid state disk (SSD) or the like, and stores font data, emulation programs, form data and the like. It can also store a dedicated printer driver 143 in accordance with the present embodiment.

It should be noted that if no external memory 134, such as a hard disk, is connected, the information used by the host computer 101 is stored in the data ROM 133c of the ROM 133. Moreover, there is no limitation to one external memory 134, and a plurality of external memories 134 may be provided. For example, the output device may be configured such that it is possible to connect a plurality of option font cards in addition to the built fonts, or external memories storing for example programs for interpreting printer control languages of different language types.

An operation unit 142 is provided with an operating panel for receiving an operation input from a user, on which for example an LED display and switches for operating the operating panel are arranged (not shown in the drawings). It is also possible to provide an NVRAM not shown in the drawings, and to store printer mode setting information from the operating panel.

Based on a control program stored in the program ROM 133b of the ROM 133, the CPU 132 outputs image signals as output information via the print unit I/F 136 to the print unit 137. Moreover, the CPU 132 is able to communicate with the host computer 101 via the network I/F 138. When receiving print data sent from the host computer 101, information inside the output device 102 can be notified to the host computer 101.

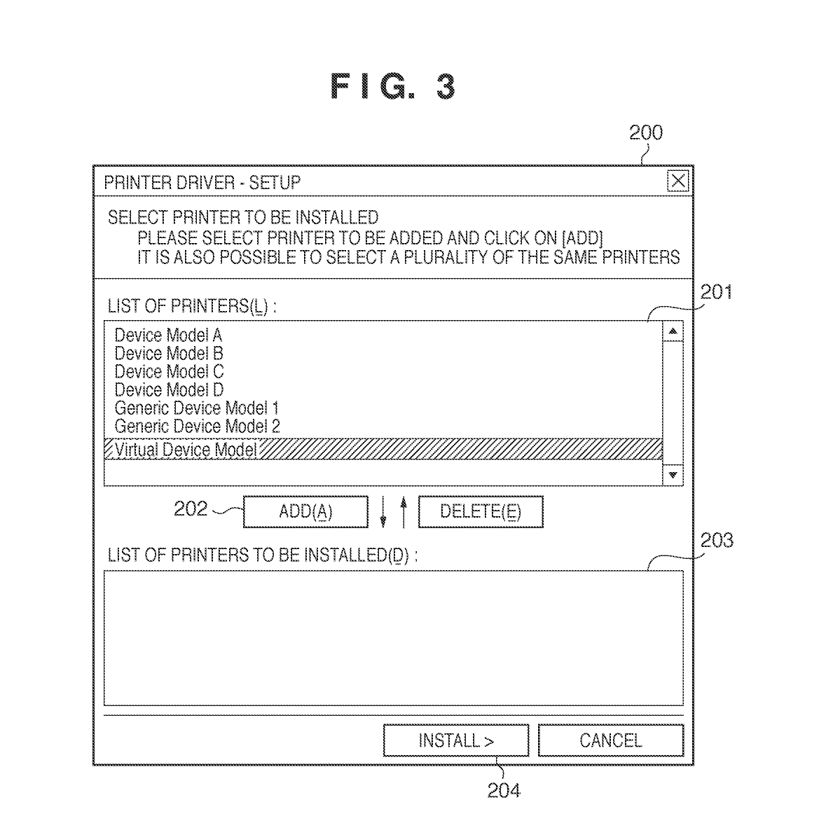

FIG. 3 shows a user interface screen 200 of a printer driver installer 129. The user interface screen 200 is displayed on the display 120 when the printer driver installer 129 is executed. A list of installable printer drivers is displayed in a printer list 201. In the displayed list, “Device Model A” is a dedicated printer driver supporting an output device of device model A. “Device Model B” is a dedicated printer driver supporting an output device of device model B. “Device Model C” is a dedicated printer driver supporting an output device of device model C. “Device Model D” is a dedicated printer driver supporting an output device of device model D. “Generic Model 1” is a universal printer driver supporting device models A and B. “Generic Model 2” is a universal printer driver supporting device models C and D. “Virtual Device Model” is a virtual printer driver that can support any output device.

The user selects a desired model on this user interface screen 200, pushes an add button 202, and adds the selected model or models to a printer list 203 of printers to be installed. After this, when the user pushes an “Install” button 204, the printer driver installer 129 installs the printer driver of the specified model or models.

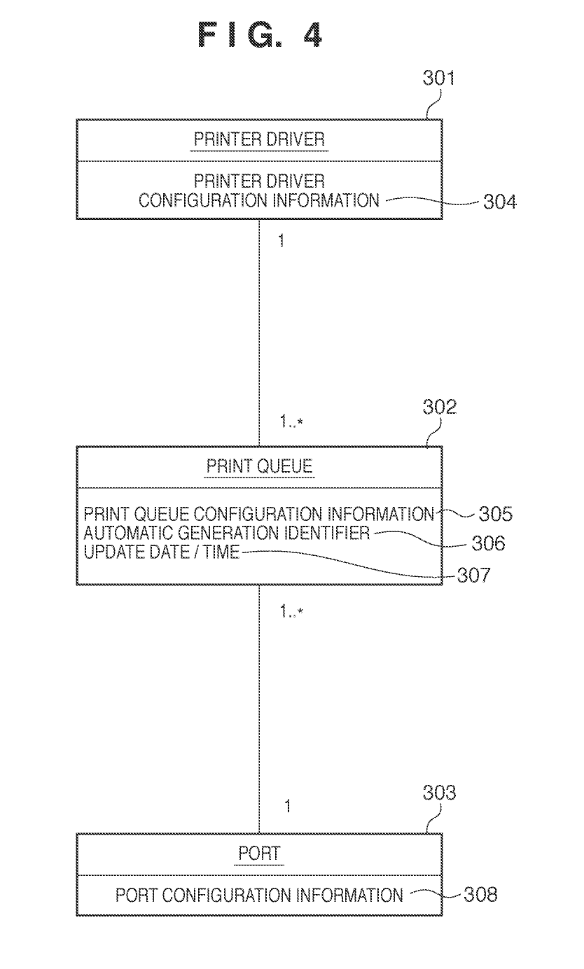

FIG. 4 is a diagram illustrating information on a printer driver, a print queue and a port, as well as the relation among them. In FIG. 4, this is illustrated using an object diagram of UML (Unified Modeling Language).

As shown in the drawing, the printer driver 301 holds printer driver configuration information 304. The printer driver configuration information 304 is made up of a driver version, a device model name, hardware information, a driver module name and the like. It should be noted that the printer driver configuration information 304 is managed by the OS 122.

A print queue 302 is an object to be printed, when printing from the application. It is possible to create a plurality of print queues 302 from the printer driver 301 of the same device model. For example, when three device models A are introduced into an office, it is possible to install one printer driver supporting this output device and to create three print queues using this printer driver.

The print queue 302 holds print queue configuration information 305. The print queue configuration information 305 is made up of a print queue name, a port name, print setting information, a job input time, and a job status, for example. It should be noted that the print queue configuration information 305 is managed by the OS 122. Furthermore, in the present embodiment, the print queue 302 holds an automatic generation identifier 306 and an update date/time 307 typical for this embodiment. This information is managed by a print job manager 125. Details will be explained further below.

A port 303 is an object that specifies an output destination on the network. There is ordinarily a one-to-one correspondence between the ports 303 and the print queues 302, but it is also possible that a plurality of print queues use the same port. The port 303 holds port configuration information 308. The port configuration information 308 is constituted by a port name, a module name, and an IP address, for example. It should be noted that the port configuration information 308 is managed by the OS 122.

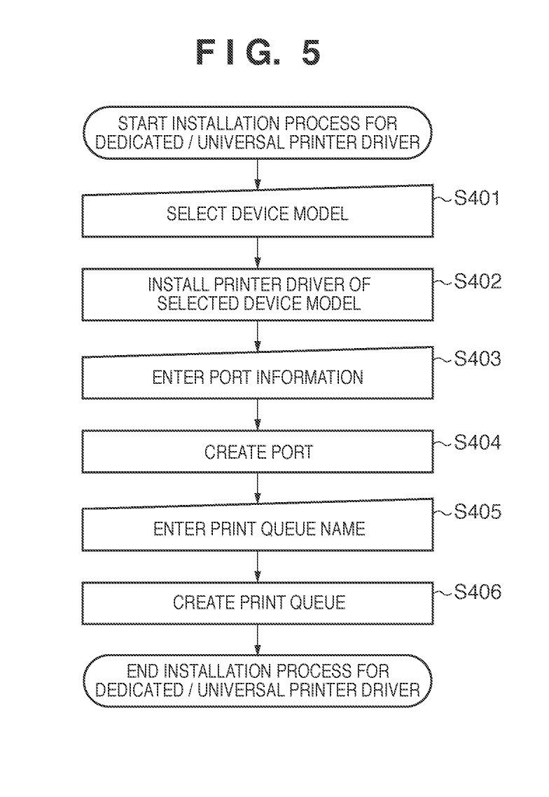

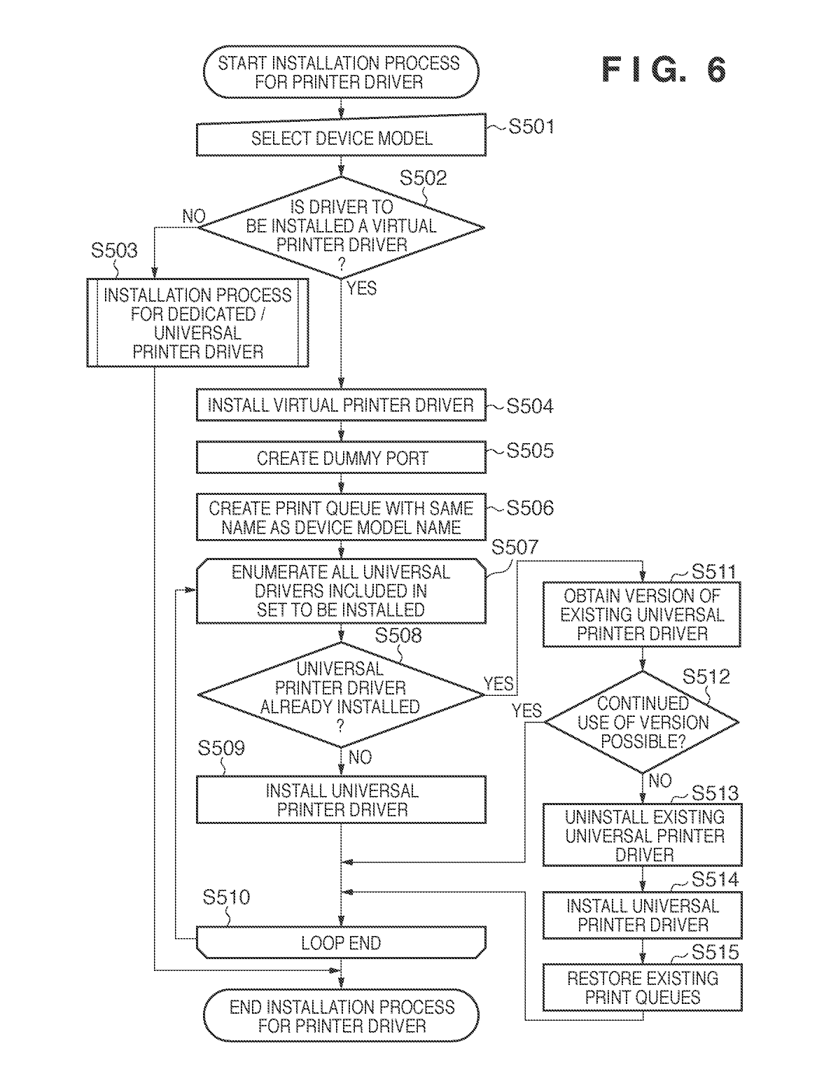

FIG. 5 is a flowchart showing a process of installing an ordinary printer driver with the printer driver installer 129. “Ordinary printer driver” refers to dedicated printer drivers and universal printer drivers. In S401, when beginning to install the printer driver, first the user selects the device model, and input of the selected device model is received. Here, it is assumed that a device model other than the Virtual Device Model is selected from the printer list 201 shown in FIG. 3. It should be noted that an installation process including also the selection of the Virtual Device Model, which is typical for this embodiment, is explained later with reference to FIG. 6.

Next, in S402, the printer driver of the device model selected in S401 is installed. Then, in S403, the user enters port configuration information 308, such as an IP address, and in S404, a port 303 is created from the entered port configuration information 308. Next, in S405, the user enters a print queue name, and in S406, a print queue 302 is created associating the printer driver installed in S402 with the port 303 created in S404. With this, the installation process of the dedicated printer driver and the universal printer driver finishes.

FIG. 6 is a flowchart showing an installation process of the printer driver with the printer driver installer 129, which is typical for this embodiment. In S501, when the installation of the printer driver begins, first the selection of the device model by the user is received. Then, in S502, it is determined whether the selected device model is a virtual printer driver. Here, if the selected device model is not a virtual printer driver, the procedure advances to S503, and a process for installing a dedicated/universal printer driver is carried out. S503 is equivalent to the processing from S402 onward in FIG. 5. Then, the installation process finishes.

On the other hand, if the selected device model is a virtual printer driver, the procedure advances to S504, and a virtual printer driver is installed. This virtual printer driver itself does not output print data to the port, so that in S505 a dummy port is created without any input from the user. Moreover, since there is no necessity to create a plurality of print queues for the virtual printer driver, a print queue with the same name as that of the device model is created in S506, without any input from the user.

In the installation process of the ordinary printer driver explained using FIG. 4, there were three inputs from the user, namely at S401, S403 and S405. On the other hand, in the installation process of the printer driver, which is typical for this embodiment, there is only one input at S501. If the printer driver installer 129 is a program that is only for virtual printer drivers, then also S501 becomes unnecessary.

That is to say, the method for installing a virtual printer driver has the effect that the burden on the user and the operation costs are reduced. The virtual printer driver does not output any print data to the ports. Accordingly, a universal printer driver is set up, in order to guarantee a minimum printing functionality. Next, a process for installing a universal printer driver is explained.

In S507 to S510, all universal printer drivers included in the set to be installed are enumerated. In the printer list 201 shown in FIG. 3, there are two universal printers, namely Generic Device Model 1 and Generic Device Model 2. Thus, in the first loop of the process, the Generic Device Model 1 is taken up, and in the second loop of the process, the Generic Device Model 2 is taken up. Next, in S508, it is judged whether the universal printer driver that was taken up is already installed on the host computer 101. Here, if it is not yet installed, the procedure advances to S509, and the selected universal printer driver is installed. Here, no print queue using the universal printer driver is created, so that the user does not become aware of the installation of the universal printer driver. Then, when the loop process ends in S510, the installation process finishes.

In S508, if the universal printer driver that was taken up already has been installed on the host computer 101, then the procedure advances to S511, and the version of the already installed universal printer driver is obtained. Then, in S512, it is determined from the version number whether the continued use is possible. Here, if it is judged that continued use is possible, the procedure advances to S510, and when the loop process finishes, the installation process finishes.

On the other hand, if it is judged in S512 that it is not possible to continue use of the already installed universal printer driver, then the procedure advances to S513, and the already installed universal printer driver is uninstalled. Then, in S514, the universal printer driver that was taken up is installed. Furthermore, in S515, print queues configured using the already installed universal printer driver prior to S513 are restored using the universal printer driver installed in S514. Then, the procedure advances to S510, and when the loop process finishes, the installation process finishes.

In the foregoing, it was explained that the printer driver installer 129 installs a virtual printer driver, and when the print queue is created, a universal printer driver is automatically installed. It should be noted that it was explained that the process of installing the universal printer driver in S507 onward is carried out by the printer driver installer 129, but it is also possible to carry out an initialization process with the virtual printer driver 126. Moreover, it may also be carried out by a setup module of a printer driver, not shown in the drawings, that is called up by the OS 122, ordinarily referred to as “vendor setup.”

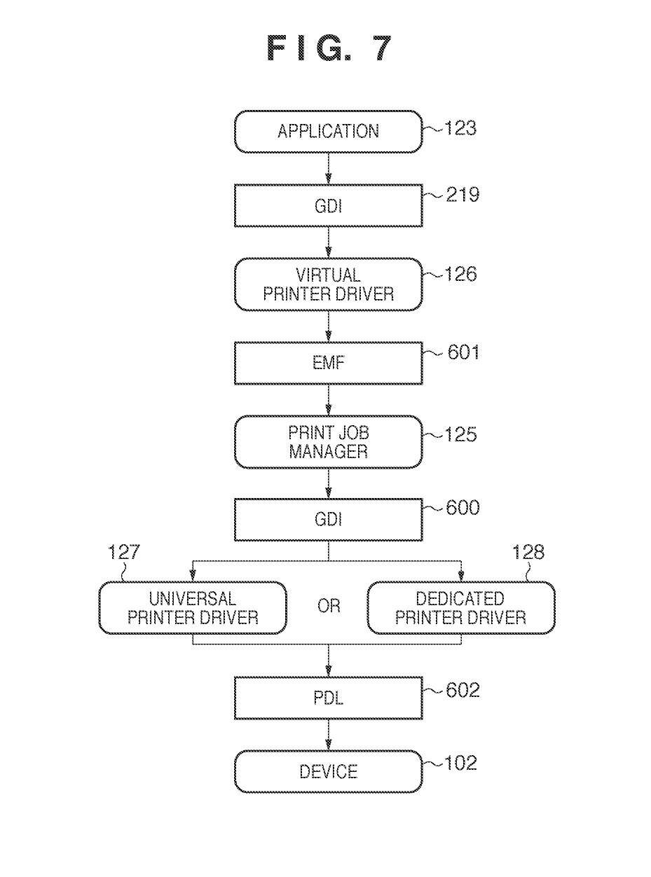

The following is an explanation of the input and output of data among the various components of the programs relating to print processing. FIG. 7 is a diagram showing the data flow of the print processing. An application 123 outputs a print instruction command through a GDI (graphic device interface) 600, which is a graphics interface provided by the OS 122, to the virtual printer driver 126. Next, the virtual printer driver 126 converts the input print instruction command into the format of an EMF (enhanced meta file) 601 and outputs it to a print job manager 125.

Here, the EMF 601 is an intermediate data format that is compatible with print instruction commands of the GDI 600, and records a series of print instruction commands that are output from the application 123 as reproducible data. In these explanations, the EMF 601 is used as the intermediate format, but as long as it is data that can reproduce the print instruction commands, it is also possible to use another format. For example, the format may also be XPS (XML Paper Specification), PDF (Portable Document Format) or another suitable freely defined format.

Next, the print job manager 125 performs a unique process explained later, such as specifying the output device or managing the universal/dedicated printer driver, and outputs the print instruction command through the GDI 600. The output print instruction command is entered into the universal printer driver 127 or the dedicated printer driver 128. Then, the universal printer driver 127 or the dedicated printer driver 128 convert it into the format of PDL 602, which can be processed by the output device 102, and output it to the output device 102. Finally, the output device 102 performs print output by processing the input PDL 602.

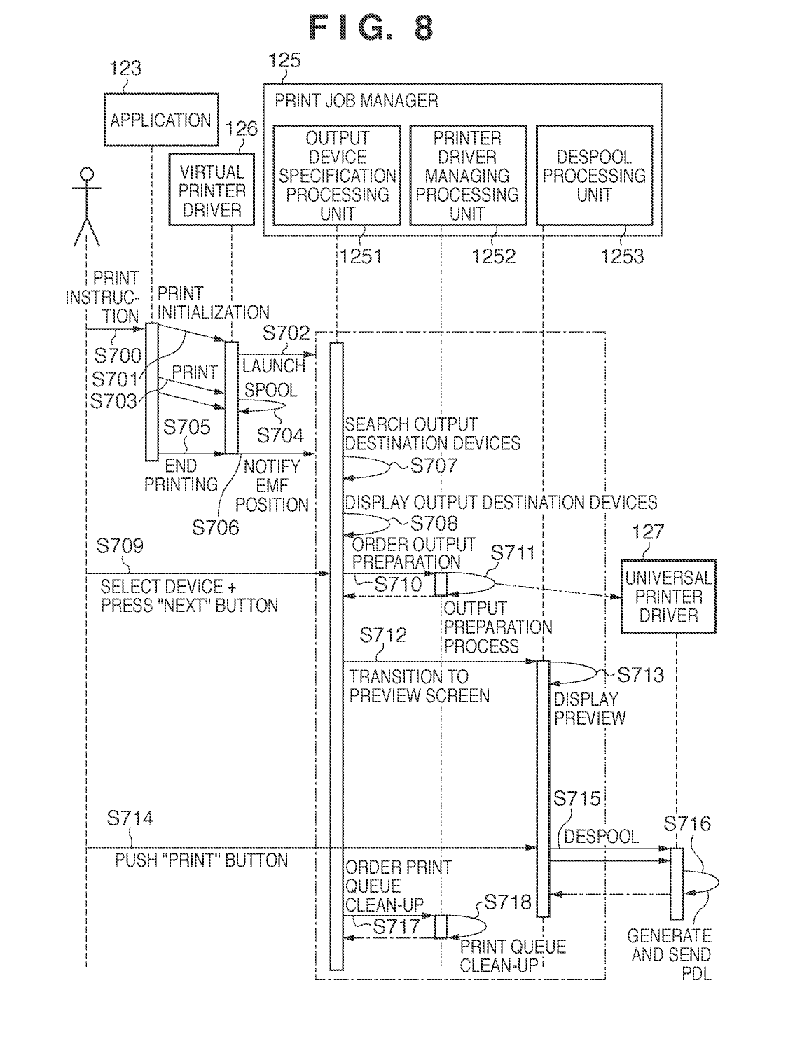

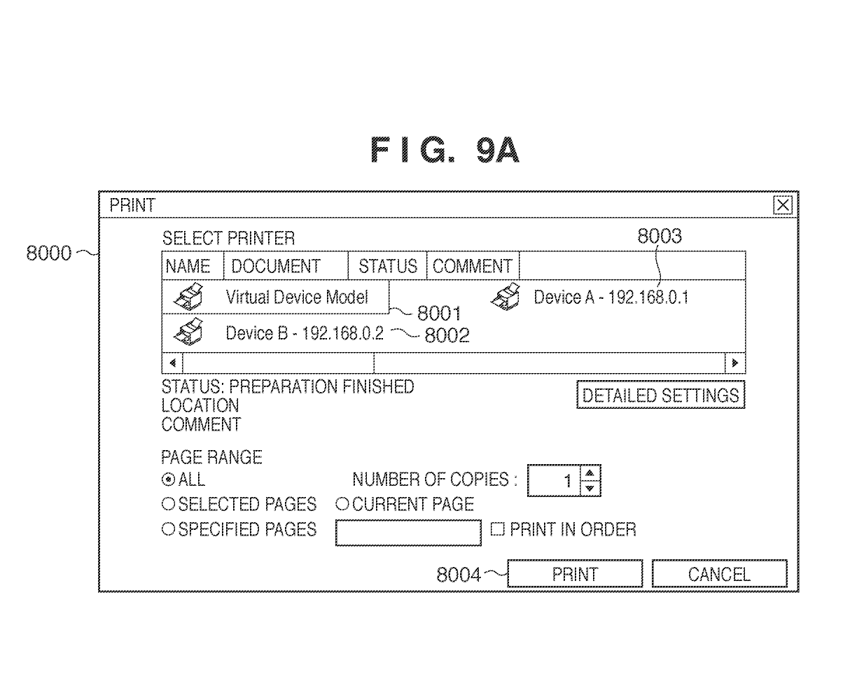

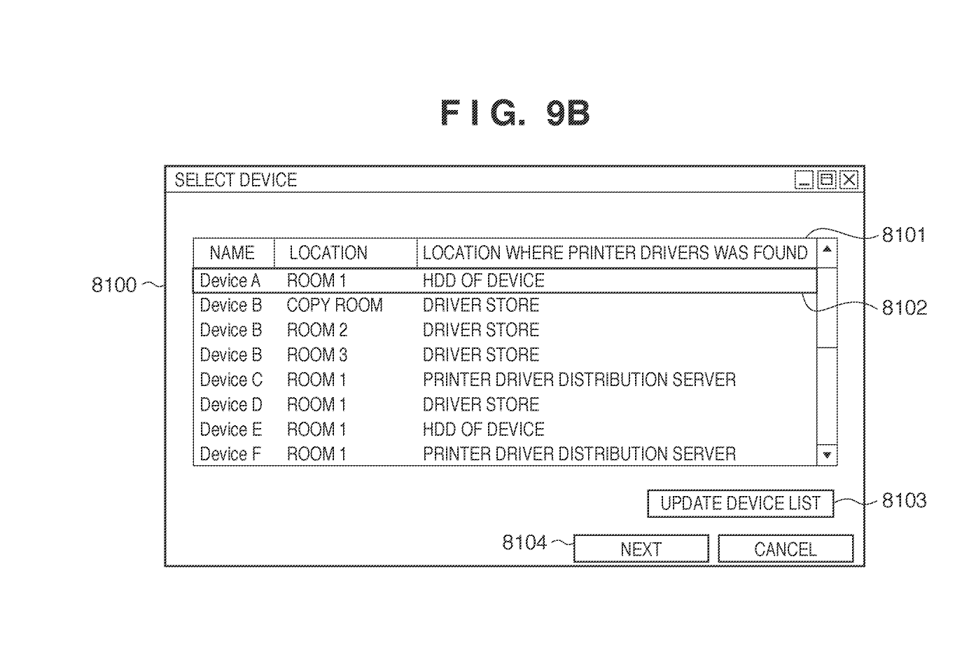

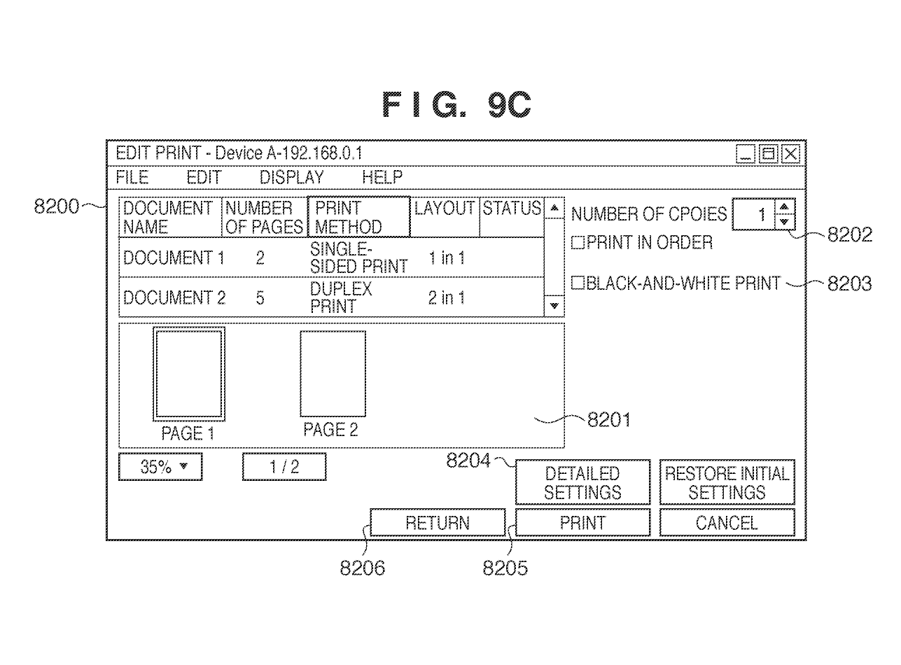

The following is an explanation of the internals of the various components of the related programs during a series of print processing and what processing is performed among them. FIG. 8 is a drawing showing a sequence of print processing. First, the user enters a print instruction (S700) for a document that the user wants to print into the application 123 with a user interface screen 8000 shown in FIG. 9A. It should be noted that in order to perform output through the virtual printer driver, the user selects the icon 8001 of the virtual device model from the icons 8001 to 8003 representing printers, and instructs printing by pushing the print button 8004.

Next, the application 123 instructs the virtual printer driver 126 to perform a print initialization (S701). Then, the virtual printer driver 126 carries out print initialization processing, and launches the print job manager 125 (S702). Here, the print job manager 125 is a program that is launched after beginning to print a document with the virtual printer driver 126, and is responsible for typical processing to be explained later, such as specifying the output device or managing the universal/dedicated printer driver. As internal components, the print job manager 125 includes an output device specifying processing unit 1251, a printer driver managing processing unit 1252, and a despool processing unit 1253.

Next, when the print job manager 125 is started up, the application 123 begins the printing with the virtual printer driver 126 (S703), and outputs a series of print rendering commands through the GDI 219. In the virtual printer driver 126, the entered series of print rendering commands is converted into EMF 601 format, and after this, saved to the external memory 121, so that the print rendering commands can be reproduced. This process is referred to as “spooling” (S704). At the end of the series of print rendering commands, the application 123 performs processing of print finishing (S705). Information on the position where the EMF 601 is saved in the external memory 121 is notified by the virtual printer driver 126 to the print job manager 125 (S706).

It should be noted that in the spooling (S704), a process of saving to the external memory 121 is carried out, but it may also be a process of outputting directly to the print job manager 125 without going through the external memory 121.

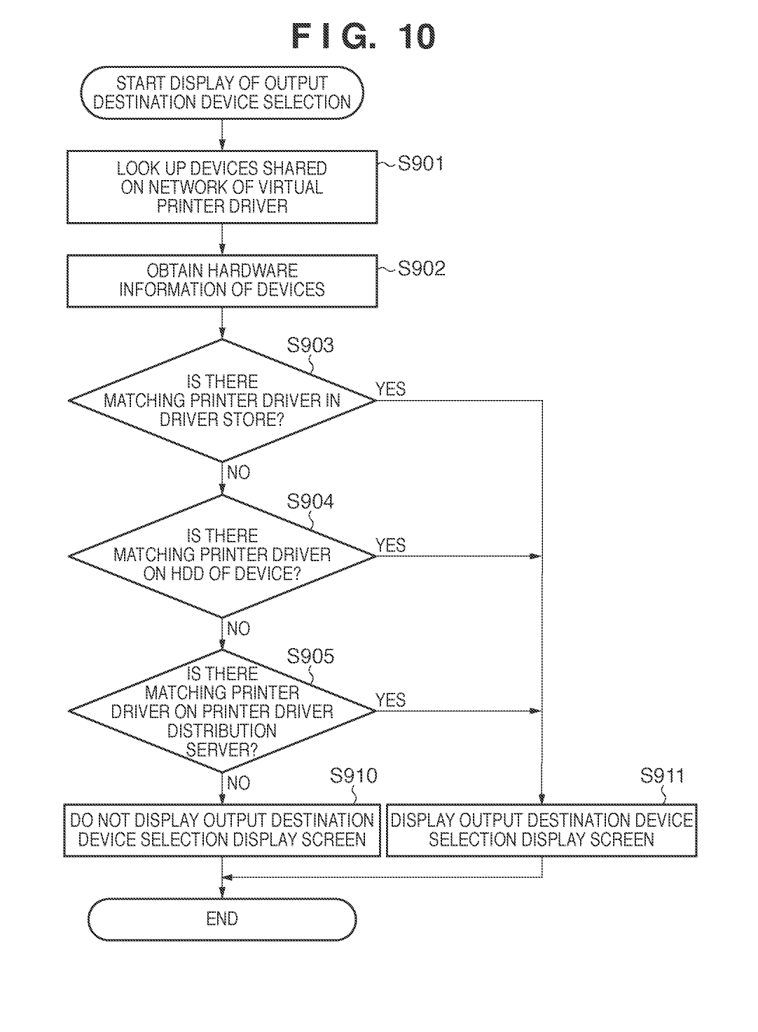

An output destination device search (S707) and an output destination device list display (S708) are explained later using FIG. 10.

A control list (output destination device list) 8101 displaying information on the output devices is arranged on a user interface screen 8100 as shown in FIG. 9B, and it is possible to select one of the output devices with a cursor 8102. Moreover, when pushing a “Device list update” button 8103, a further search on the network is carried out, and it is possible to update the output device list with the found printer drivers that are installed in the OS 122 or which can be installed to the newest status. When a “Next” button 8104 is pushed, the device that is currently selected with the cursor 8102 is decided as the output destination. That is to say, an output device specification processing unit 1251 receives the pushing of the device selection and the “Next” button (S709), and advances to the next process.

Thus, when the device serving as the output destination is decided, the output device specification processing unit 1251 orders (S710) the printer driver management processing unit 1252 to execute an output preparation process (S711). Details of this output preparation process (S711) are explained further below. As a result of the output preparation process (S711), the print queue of a universal printer driver 127 with which printing is possible on the output device 102 selected by the OS 122 or a dedicated printer driver 128 not shown in FIG. 8 is registered.

Next, the output device specification processing unit 1251 transitions from the output device specification screen shown in FIG. 9B to the screen 8200 shown in FIG. 9C of the despool processing unit 1253 (S712). The despool processing unit 1253 displays a preview of an image resulting when a print document is actually printed in a preview area 8201 (S713). The image displayed at that time is obtained by the despool processing unit 1253 reading in the spooled (S704) EMF 601, analyzing it, and rendering it in accordance with the size of the preview area 8201. A spin control 8202 and check boxes 8203 are used to update the ordinary print settings, namely the number of print-outs and black-and-white printing. Furthermore, to change not so ordinary print settings, it is possible to display a user interface that is unique to the printer driver, not shown in the drawings, by pushing a “Detailed settings” button 8204, and entering instructions to change the print settings. At this time, if the print queue for the output destination is a print queue of the dedicated printer driver 128, then print settings that are more sophisticated than for a universal printer driver 127 are possible. A “Return” button 8206 is used to return by transitioning from the present screen 8200 to the output device specification screen 8100, which is the previous screen.

When the user pushes a “Print” button 8205 (S714), the despool processing unit 1253 instructs the universal printer driver 127 to despool (S715), and issues a series of print rendering commands. Here, “despooling” refers to the opposite of spooling, that is, to read out the data of the EMF 601 from the notified storage position information, analyze it, and reproduce the print rendering commands. Thus, the print processing that was interrupted in order to carry out the characteristic processing with the print job manager 125 is resumed, and the print document is output. Then, the universal printer driver 127 converts the entered print rendering commands into PDL 602, and sends the PDL 602 through the network I/F 138 to the output device 102 (S716). When the print process finishes, the output device specification processing unit 1251 orders (S717) the printer driver managing processing unit 1252 to execute print queue clean-up processing (S718). Finally, the print job manager 125 finishes the program.

Referring to FIG. 10, the following is an explanation of the detailed processes of looking up the output destination device with the output device specification processing unit 1251 (S707) and of the output destination device list display (S708). This process displays the found output devices in an output destination device list 8101, if a printer driver of a searched output device is installed or installable in the OS 122. On the other hand, if no printer driver is installed or installable in the OS 122, then the looked up output devices are not displayed in the output destination device list 8101, and the process finishes.

First, in S901, the output device specification processing unit 1251 looks up the output devices. Here, “look up” means to communicate with the output devices 102a, 102b connected over the LAN 104, and to obtain information concerning their names, locations, IP addresses and hardware IDs. As a communication method, a protocol such as SNMP (Simple Network Management Protocol),which is known in the art, may be used.

Ordinarily, it is impossible to know in advance the status of the output devices 102a, 102b before they are turned on or connected to the LAN 104. Therefore, the output device specification processing unit 1251 attempts communication with all output devices at every print instruction. To communicate with all devices on the network, a broadcasting method, which is also known in the art, may be used.

When the output device specification processing unit 1251 sends the data for obtaining information of SNMP through the network I/F 118 by this broadcasting method, then all output devices 102 that can be reached over the LAN 104 receive the data for obtaining information. Then, the output devices 102 send information such as their names or locations, specified as the information to be obtained, as the response data through the network I/F 138, the output device specification processing unit 1251 successively receives this response data. Then, the received information is stored in the RAM 112.

Next, the dedicated printer driver 143 that is optimal for the output is searched on the host computer 101, the printer driver distribution server 103, and the output devices 102a, 102b. First, at S902, hardware information on the output devices is obtained. Here, a hardware ID that is used for plug-and-play installation is obtained as the hardware information. This hardware ID is obtained in the process of looking up the output devices in S901, and retrieves the information stored in the RAM 112.

Next, in S903, it is determined whether there is a matching driver in a driver store. A “driver store” is a database system for device drivers, which was introduced with Windows Vista™, and is a mechanism by which a package of uninstalled printer drivers is stored in the OS 122. The output device specification processing unit 1251 determines by inquiring with the OS 122 whether there is a printer driver fitting the hardware information of the output device 102 obtained in S902 among the printer drivers stored in this driver store.

If the result of this inquiry is that there is a matching printer driver, then the procedure advances to S911, the output device specification processing unit 1251 retrieves such information as the device name and location from the RAM 112, and displays the output destination device list 8101 specifying the output device. On the other hand, if the result of the inquiry is that there is no matching printer driver, then the procedure advances to S904, the output device specification processing unit 1251 searches within the output devices 102, and determines whether there is a matching printer driver.

As explained above, the output device 102 can store the dedicated printer driver 143 that is necessary for utilizing the output device itself in its external memory 134. Moreover, the output device specification processing unit 1251 can inquire over the LAN 104 at the output device 102 whether there is a printer driver matching the hardware information. Here, such an inquiry can be made using RPC (Remote Procedure Call) or HTTP (Hyper Text Transfer Protocol).

If the result of the inquiry is that there is a matching printer driver, then the procedure advances to S911, the output device specification processing unit 1251 retrieves such information as the device name and location from the RAM 112, and displays the output destination device list 8101 specifying the output device. On the other hand, if the result of the inquiry is that there is no matching printer driver, then the procedure advances to S905, and the output device specification processing unit 1251 determines whether there is a matching printer driver within the printer driver distribution server 103. As with the output device 102, the output device specification processing unit 1251 can send an inquiry via the LAN 104 and the Internet 105 also to the driver distribution server 103.

If the result of the inquiry is that there is a matching printer driver, then the procedure advances to S911, the output device specification processing unit 1251 retrieves such information as the device name and location from the RAM 112, and displays the output destination device list 8101 specifying the output device. On the other hand, if the result of the inquiry is that there is no matching printer driver, then the procedure advances to S910, and the output device specification processing unit 1251 does not display an output destination display list 8101 specifying an output device.

With the processing shown in FIG. 10, the devices displayed in the output destination device list 8101 specifying the output devices are the output devices that have been found for which printer drivers are installed or installable in the OS 122.

Consequently, the user can select an output destination device whose printer driver can be utilized, so that the effect can be attained that it can be avoided that no printer driving matching the output destination device can be found and printing is not possible.

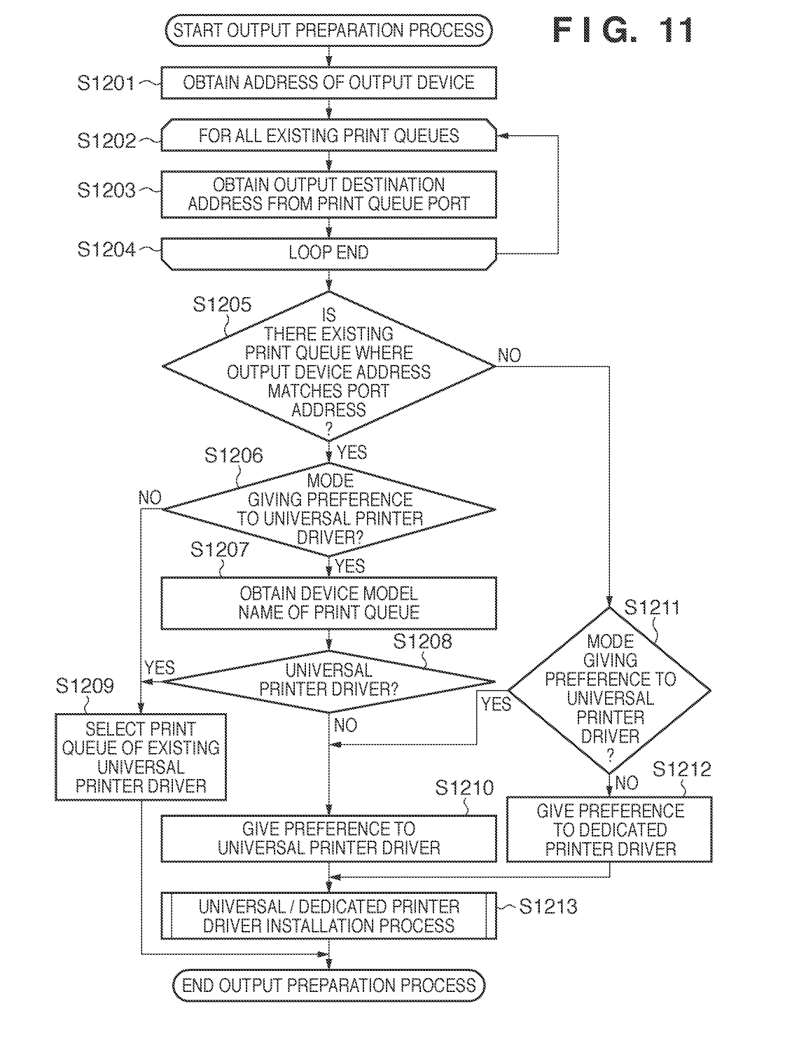

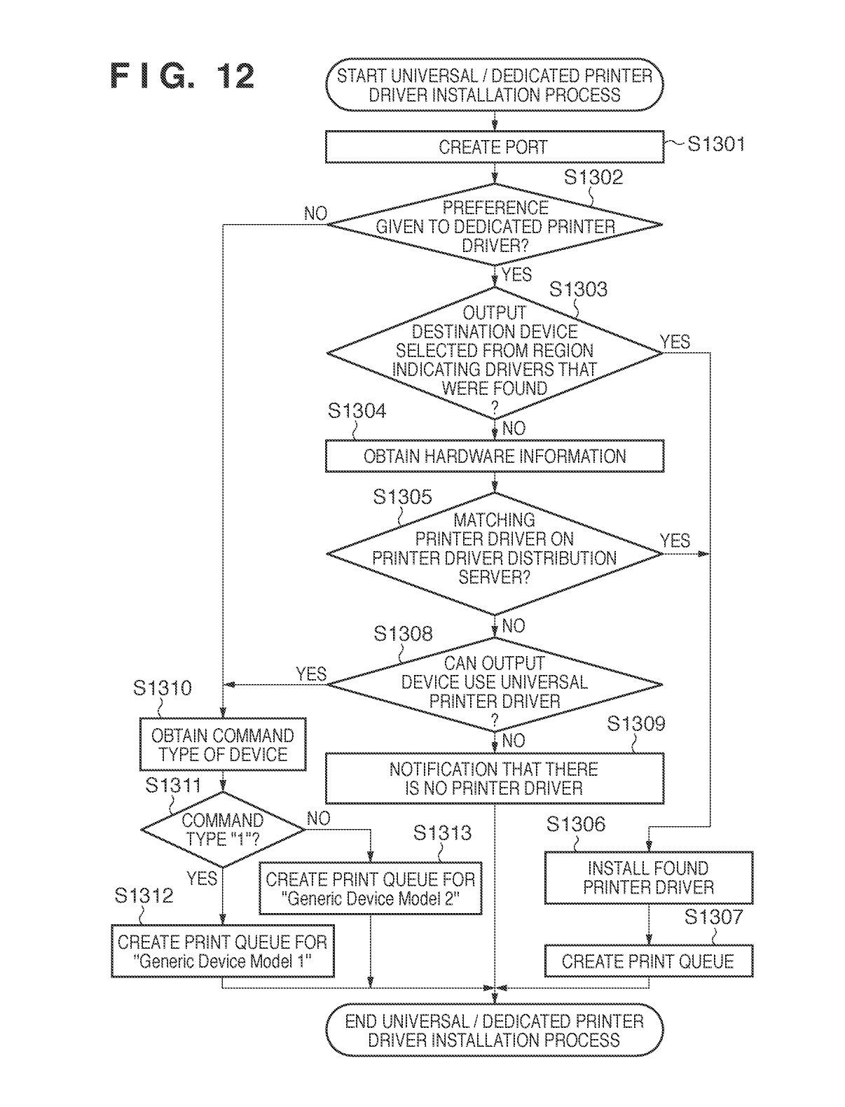

Next, the processing of the output preparation process (S711) in the printer driver managing processing unit 1252 is explained in detail with reference to FIGS. 11 and 12. In this processing, if there is a print queue for printing to the output device 102, it is selected, and if not, then a new print queue is created or the most suitable printer driver is installed.

First, in S1201, when the output preparation process begins, the printer driver managing processing unit 1252 obtains information on the IP address of the output device 102. As the IP address information, the information obtained in the output device search process (S707), and stored in the RAM 112 is retrieved. Next, in S1202 to S1204, the IP addresses of the port associated with the print queue is obtained for all print queues registered in the OS 122.

Next, in S1205, it is determined whether there is a print queue where the IP address of the output device 102 matches the IP address of the port. Details are explained further below, but a print queue is created for each output device. However, if a separate print queue is created every time that printing is performed on the same output device, then a large number of redundant print queues will be registered. In order to avoid this situation, the IP addresses of the output device and all print queues are compared, and it is determined whether there is not a print queue with which output is possible among the existing print queues. If there is such a print queue with which output is possible, then the procedure advances to S1206, and if there is no such print queue, then the procedure advances to S1211.

In S1206, it is furthermore determined whether a mode is set in which preference is given to the universal printer driver. There is the possibility that a print queue of the dedicated printer driver 128 is included among the print queues with which output to the desired output device 102 is possible. However, there are also users that want to use a simple and stable universal printer driver 127 without requiring sophisticated functionality. Therefore, it is conceivable to provide functionality enabling switching to a mode in which preference is given to a universal printer driver, for example with a user interface not shown in the drawings. If this mode is given, that is, if preference is given to a universal printer driver, then the procedure advances to S1207, and if not, then the procedure advances to S1209.

In S1207, the device model name of the print queue is obtained, and in S1208, it is determined whether the model name of the device is one of a universal printer driver. Whereas the name of the print queue can be changed by the user, the device model name of the universal printer driver is a unique name, such as “Generic Device Model 1”. Thus, if the device model name of the print queue is known, it can be determined which kind of driver it is.

Here, if it is a universal printer driver, then the procedure advances to S1209, and if not, then the procedure advances to S1210. If the procedure advances to S1209, the print queue of the corresponding universal printer driver is decided as the output destination, and the output preparation process finishes. If the procedure advances to S1210, that is, if it is determined that there is an already existing print queue of a dedicated printer driver, then a universal printer driver is preferentially installed in a universal/dedicated printer driver installation process (S1213) explained further below. Then, the process finishes.

Moreover, in S1211, which is the case that there is no matching print queue in S1205, as in S1206, it is determined whether a mode is set in which preference is given to the universal printer driver. If this is true, then the procedure advances to S1210, and if this is false, then the procedure advances to S1212. In S1212, there is no already existing print queue to which output is possible and a mode is set in which no preference is given to the universal printer driver, so that it is decided to install a matching optimum driver. Then, a universal/dedicated printer driver installation process (S1213) is executed, and the process finishes.

FIG. 12 is a flowchart showing in detail the processing of the universal/dedicated printer driver installation process (S1213) in the printer driver managing processing unit 1252. First of all, in S1301, when the printer driver managing processing unit 1252 starts the processing, a port for output is created. Next, in S1302, it is determined whether a mode is set in which preference is given to a dedicated printer driver. If this is true, then the procedure advances to S1303, and if this is false, then the procedure advances to S1310.

In S1303, the printer driver managing processing unit 1252 judges whether an output destination device has been selected from the output destination device list 8101 indicating that the printer driver of the specified output destination device has been found. If it is judged that an output destination device has been selected from the output destination device list 8101, then the procedure advances to S1306, and the printer driver managing processing unit 1252 installs the matching printer driver. Then, in S1307, a print queue is created in association with the port created in S1301, and the process finishes.

On the other hand, if in S1303 no output destination device has been selected from the output destination device list 8101, then the procedure advances to S1304. These S1304 to S1305 constitute a process of searching the optimal dedicated printer driver 143 from the host computer 101, the printer driver distribution server 103, or the output devices 102a and 102b.

First, in S1304, information on the hardware of the output device is obtained. Here, a hardware ID that is used for plug-and-play installation is obtained as the hardware information. This hardware ID is obtained in a process of searching the output devices (S707), and retrieves information stored in the RAM 112.

Next, in S1305, it is searched whether there is a printer driver on the printer driver distribution server 103. First, an inquiry is made by RPC or HTTP or the like via the LAN 104 and the Internet 105, whether there is a matching printer driver on the printer driver distribution server 103. If the result of the inquiry is that there is a matching printer driver, then the procedure advances to S1306, and a printer driver package from the printer driver distribution server 103 is transferred to the host computer 101 and stored in the external memory 121. Then, the printer driver managing processing unit 1252 installs the matching printer driver. Finally, in S1307, a print queue is created in association with the port created in S1301, and the process finishes.

On the other hand, if in S1305 there is no matching printer driver on the printer driver distribution server 103, then the procedure advances to S1308, and the printer driver managing processing unit 1252 judges that the output device 102 can use a universal printer driver. Here, if it is judged that the printer driver managing processing unit 1252 can use a universal printer driver, then the procedure advances to S1310.

In S1310 to S1313, as an alternative for the case that no matching printer driver could be found anywhere, a print queue of the universal printer driver installed in advance in S500 to S516 is created. First of all, in S1310, the printer driver managing processing unit 1252 obtains command type information of the output device 102 via the LAN 104, and judges whether it is “1” or not. This “command type information” is information representing the type of PDL 602 that can be processed by the output device 102. The universal printer driver 127 is a driver that issues PDL that can be output to a plurality of device models, but after all it can issue only one kind of PDL.

Consequently, since output to device models supporting different PDLs is not possible, the command type information is obtained, and the compatibility is confirmed. Here, it is assumed that output devices are utilized that support two kinds of PDL, namely either “1” or “2”, so that it is judged whether the command type information is “1”. If it is “1”, then the procedure advances to S1312, and otherwise, namely if it is “2”, the procedure advances to S1313.

In S1312, a print queue of the “Generic Device Model 1” supporting the command type “1” is created, and the process finishes. On the other hand, in S1313, a print queue of the “Generic Device Model 2” supporting the command type “2” is created, and the process finishes. It should be noted that when creating a print queue, it is associated with the port created in S1301.

On the other hand, if it is judged that the printer driver managing processing unit 1252 cannot use a universal printer driver for the output device 102, then the procedure advances from S1308 to S1309. In S1309, the printer driver managing processing unit 1252 notifies the user with a warning screen or the like that there was no universal or dedicated printer driver for the output device 102 that can be used. Finally, the process of installing a universal/dedicated printer driver is stopped, and the process finishes.

### Modified Example

In the above-described embodiment, the output device specification processing unit 1251 searched a printer driver matching the output device 102 in a driver store or on the printer driver distribution server 103, for example. However, since the printer driver distribution server 103 is located on the Internet 105, whose data transfers speed is low, searching for a printer driver takes more time than searching in an output device 102, for example. Accordingly, in this modified example, considering the time for searching a printer driver, the search locations are searched in accordance with a priority order by searching first the driver store and then the HDD of the device, carrying out the output device specification process.

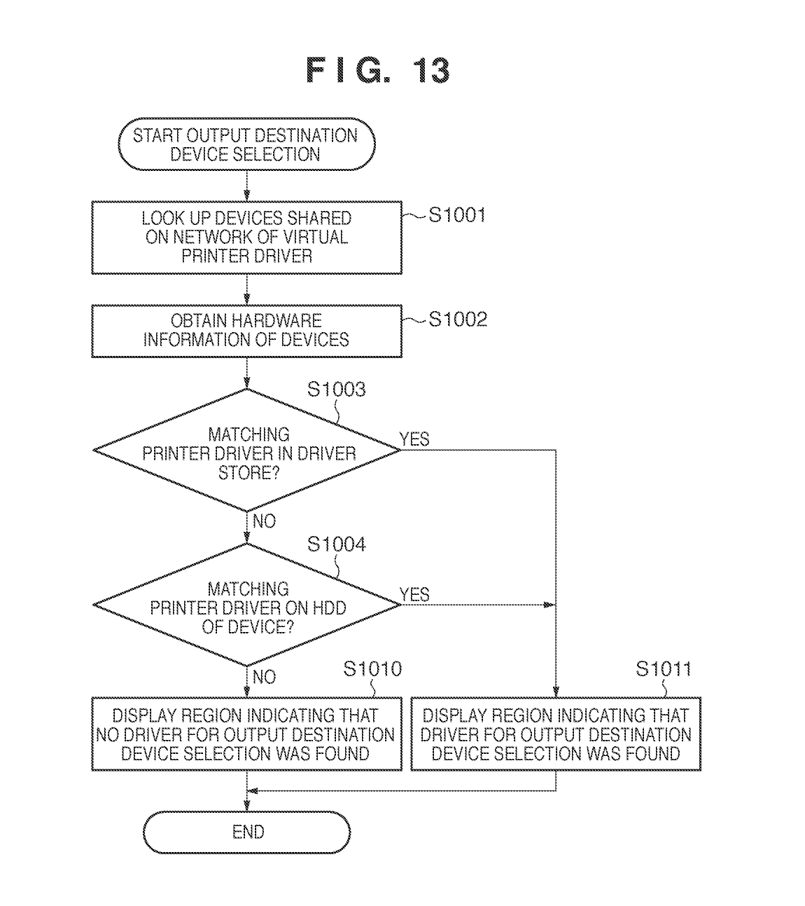

FIG. 13 is a flowchart showing the output device specification process according to the modified example. Steps S1001 to S1004 in FIG. 13 are the same as the steps S901 to S904 in FIG. 10, so that their further explanation is omitted. It should be noted that in S1003, the driver store, which is the first search location in the priority search order, is searched, and in S1004, the HDD of the device, which is the second search location in the priority search order, is searched.

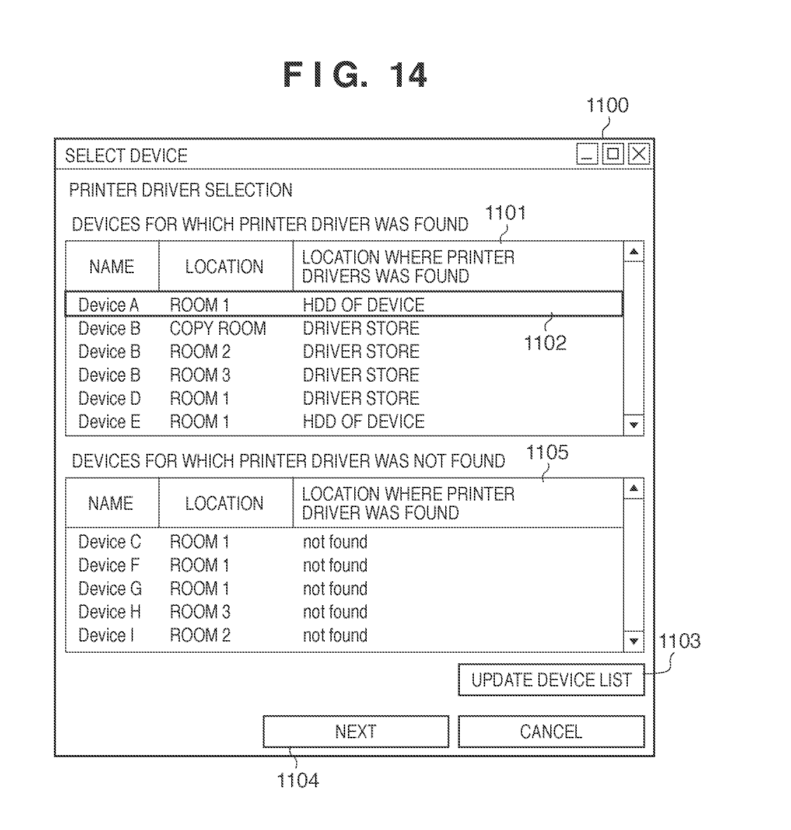

As in the above-described embodiment, if it is determined in S1003 or S1004 that there is a matching output device, then the procedure advances to S1011. In S1011, a control list (output destination device list) 1101 as shown in FIG. 14 specifying the output devices is displayed. Here, the display is the same as the display shown in FIG. 9B.

On the other hand, if is determined in S1003 and S1004 that the result of the inquiry is that there is no matching output device, then the procedure advances to S1010, and the output destination display list 1105 shown in FIG. 14 is displayed. The output destination display list 1101 shown in FIG. 14 is a region displaying the output devices for which a printer driver matching the output device has been found. By contrast, the output destination display list 1105 is a region displaying the output devices for which no printer driver matching the output device has been found.

In the modified example, the driver search locations up to the second priority search order are searched. It is also possible to register in advance in the output device specification processing unit 1251 up to which priority search order is to be searched as a driver search location, or to let the user select this prior to searching a printer driver.

With this procedure, the search locations of the printer drivers matching the output device are provided with a priority order, and by assigning a high priority order to a search location with a fast response, the device search results are displayed faster than in the case that all locations are searched.

Moreover, with the display shown in FIG. 14, it can be seen at a glance whether a printer driver matching the output device 102 can be immediately utilized or whether a further search is necessary to see if there is a printer driver that can be utilized.

With the processing shown in FIG. 13, if printer drivers are found that match the output devices 102, then the output devices 102 are displayed in a region of the output destination device list 1101 shown in FIG. 14. On the other hand, if no printer driver matching the output devices 102 is found, then the output devices 102 are displayed in a region of the output destination device list 1105.

However, depending on the device types that are set up in an office, it may occur that for all or almost all of the output device 102 no matching printer driver is found, displaying the region of the output destination device list 1105.

In such a case, the users in the office individually access the printer driver distribution server 103, which takes a long time to search for a printer driver (S1305), and an installation must be performed, so that the efficiency is still poor.

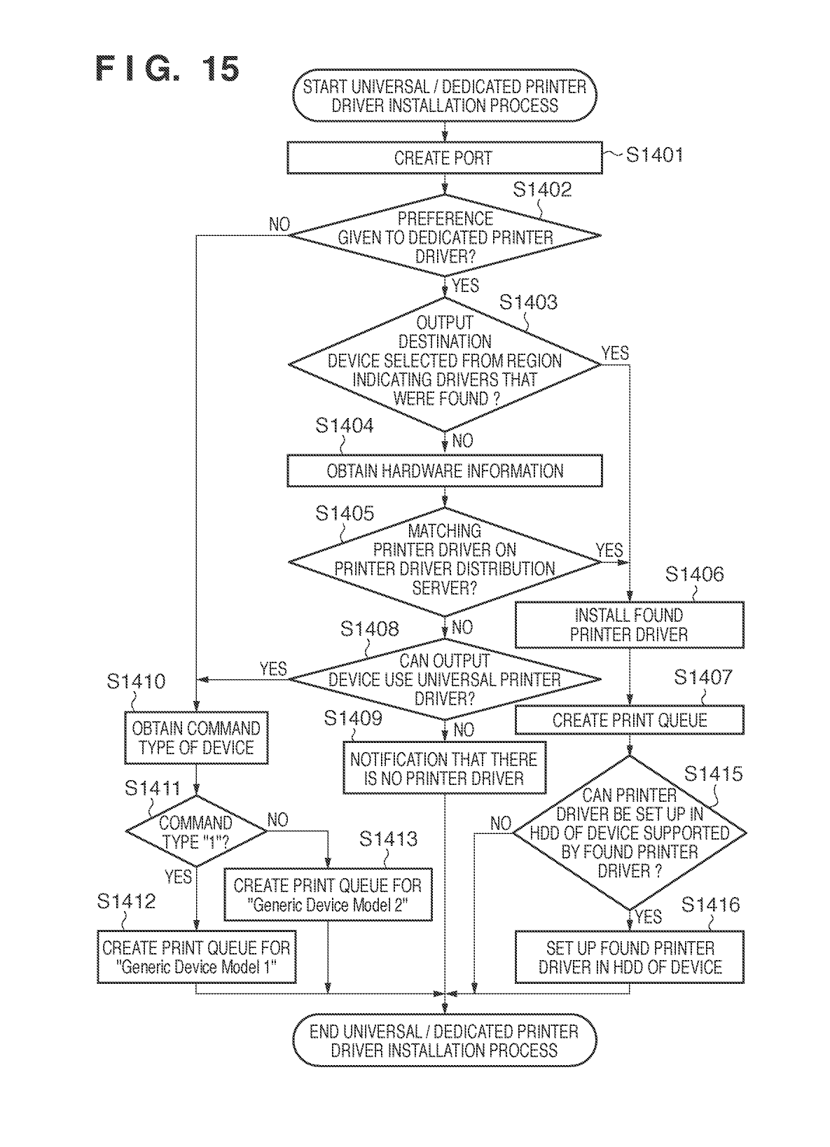

Accordingly, in this modified example, the focus is on the fact that there is the possibility that a plurality of users within an office utilize the system according to the present invention, and referring to FIG. 15, a process is explained in which drivers are set up in a location that can be accessed by a given user as well as by other users, and for which the driver search does not take a long time. It should be noted that the processing from S1401 to S1413 in FIG. 15 is the same as the processing from S1301 to S1313 in FIG. 12, so that respective explanations are omitted.

In S1415, it is judged whether the printer driver managing processing unit 1252 can be accessed also by other users, and drivers can be set up at a driver search location where the driver search does not take a lot of time. For example, if a matching driver has been found on the printer driver distribution server 103, then it is judged whether the driver can be set up in the HDD 134 of the device. It should be noted that the reason for the HDD 134 of the device is that it can be accessed by other users besides the users of the device as well, and there is a high possibility that it is a location with which the driver search takes less time than with the printer driver distribution server 103.

Here, if the printer driver managing processing unit 1252 judges that printer drivers matching the output device 102 can be set up in the HDD 134 of the device, then the procedure advances to S1416. In S1416, the printer driver managing processing unit 1252 sets up a printer driver matching the output device 102 inside the HDD 134 of the device. On the other hand, if the printer driver managing processing unit 1252 judges that a printer driver matching the output device 102 cannot be set up in the HDD 134 of the device, then the process finishes.

Thus, it is possible to set up a driver at a driver search location that can be accessed also by other users besides the user of the device, and where the search for the driver does not take a lot of time.

With this modified example, by setting up a driver at a driver search location that can be accessed also by other users and where the search for the driver does not take a lot of time, other users do not need to search driver search locations that take a lot of time to search, so that the search time can be shortened.

Moreover, instead of searching up to a search location of a certain priority search order, it is also possible to set a time at which the driver search times out, to carry out the driver search until the time-out, and then display the results.

In accordance with the present invention, it is possible to select an output device supported by a printer driver that can be installed, so that it is possible to avoid a situation in which no printer driver matching the output destination device can be found and printing is not possible.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-130449, filed Jun. 7, 2010, which is hereby incorporated by reference herein in its entirety.

What is claimed is:

1. A print control apparatus for installing a printer driver supporting an output device specified by a user, the apparatus comprising:
an obtaining unit that obtains hardware information on an output device by looking up the output device on a network;
a search unit that searches for a printer driver matching the output device from the hardware information obtained with the obtaining unit; and
a display unit that displays a screen for specifying the output device if a printer driver matching the output device has been found by the search unit.

2. The apparatus according to claim 1, wherein, if no printer driver matching the output device has been found by the search unit, the display unit further displays the fact that no printer driver matching the output device was found.

3. The apparatus according to claim 1, wherein a priority order is assigned to respective search locations of printer drivers to be searched, and the search unit searches for the printer driver in accordance with the priority order.

4. The apparatus according to claim 1, wherein a time period for searching for the printer driver is set in advance, and the search unit searches for the printer driver until the set time period has elapsed.

5. The apparatus according to claim 1, further comprising:
an installation unit that installs a printer driver supporting the output device specified by the user on the screen displayed by the display unit;
a judgment unit that judges whether the installed printer driver can be accessed also by other users, and whether the printer driver can be set up at a search location that does not take a lot of time to search; and
a storage unit that, if the judgment unit has judged that the printer driver can be set up at such a search location, stores the printer driver at that search location.

6. A display method for a print control apparatus for installing a printer driver supporting an output device specified by a user, the method comprising:
obtaining hardware information on an output device by looking up the output device on a network;
searching for a printer driver matching the output device from the hardware information obtained in the obtaining step;
displaying a screen for specifying the output device if a printer driver matching the output device has been found in the searching step.

7. A computer-readable recording medium storing a program for executing on a computer the steps of the display method for a print control apparatus according to claim 6.
